(19) United States
(12) Patent Application Publication
(10) Pub. No.: US 2006/0225646 A1
(43) Pub. Date: Oct. 12, 2006

(54) Apparatus and method for applying icing

(75) Inventors: Iver J. Phallen, Youngstown, NY (US); Kirk D. Higner, Kenmore, NY (US); Bryan E. Ferry, Akron, NY (US)

Correspondence Address: John C. Thompson, 69 Grayton Road, Tonawanda, NY, 14150, US

(73) Assignee: Oden Corporation

(21) Appl. No.: 11/100,818

(22) Filed: Apr. 7, 2005

(51) Int. Cl. A23G 3/20; B05C 5/00

(52) U.S. Cl. 118/24; 118/13

(57) ABSTRACT

An apparatus for applying icing to baked goods of any shape, such as cakes, at a flow rate of icing of about 1 gallon per minute (US). The apparatus includes a positive displacement sanitary design gear pump which meets 3A sanitary standards, the pump having symmetrical displacement rotors; an icing reservoir mounted closely adjacent an intake port of the pump, structure for forcing the icing from the reservoir into the intake pump, and tubular discharge pathway extending from the pump to an icing dispensing nozzle assembly. The pathway includes a vertical rigid tubular portion, a relatively short flexible horizontal portion, and a fast-acting positive shut-off valve between the rigid and flexible portions. The icing dispensing nozzle is further provided with an icing flow on-off switch integrating high pressure pumping and the fast acting high pressure positive shut-off valve with the low pressure nozzle valve.

### TECHNICAL FIELD

The present invention relates generally to an apparatus and method for applying icing (also termed frosting and fondants) to baked goods, and particularly to cakes of all sorts and styles for the purpose of covering all exposed areas of the cake with an icing and as distinct from applying icings for decorative purposes.

### BACKGROUND OF THE INVENTION

The icing or frosting of a variety of baked goods, in particular cakes, is a familiar and wide spread practice.

In a commercial setting, many cakes are produced and sold in relatively high volume bakeries. Many of these bakeries are located as departments within large chain stores, such as Costco or Sam's Club in the United States, as well as in-store bakeries found in major supermarket chains.

In these and other commercial baking establishments, the icing and decorating of cakes are still manual processes. In this regard, it is important to understand that the icing or frosting of a cake and the decorating of a cake are distinct and different processes. In the case of icing, the large exposed area surfaces of the cake are covered in icing (often referred to as the base frosting), typically covering it completely. This covering consumes a significant amount or volume of icing which, if supplied by the invention herein disclosed, requires icing or frosting flow at comparatively high rates.

In the case of cake decorating, icings are used to create patterns, designs, pictures and the like, using small beads or streams of frosting representing a comparatively small amount or volume of icing, applied at correspondingly low flow rates. The decorating icing is generally applied over the top of or onto the base frosting.

In the bakery settings described, the icing of cakes is generally a manual process. As such, icing is generally produced in relatively small batches using standard bakery mixing equipment.

The icing thus mixed from various dry and liquid ingredients may then be supplied to the bakery workers in a tub or pail or bowl, and the icing then applied to the cake using a suitable spatula to spread, smooth, and blend the icing on the cake until it is completely covered. This method is the traditional means. Another common method requires the squeezing of icing onto the cake from plastic squeeze bags or paper funnels or the like. The deposited icing is then spread, smoothed and blended by hand using a spatula or similar purpose implement.

In the described settings, as well as others including chain store central commissaries, larger catering kitchens, and multiple retail outlet bakeries, automation of cake icing has proved to be impractical. This is the case in large measure because of the large variety of cakes and icings offered for sale. The large number of combinations means that only a few varieties are made in any quantities, and these are usually done in relatively small batches or groups. More typically, cakes are custom ordered and specified in terms of size and icing flavor. Further, demand volume varies with time of week, season and particular holidays. Thus, use of a fully automated manufacturing or production line is simply not practical.

It is also important to note that bakery workers are typically relatively unskilled, and thus any automation equipment provided must be relatively simple and easy to operate in a safe and sanitary manner.

The need for an effective and easy to use icing system for bakery goods (particularly cakes), as distinct from a cake decorating system, is further driven by the persistent, wide spread, and substantial ergonomic problems associated with the present methods. It is well known and understood by those in the field that a high incidence of repetitive stress syndromes, including carpal tunnel syndrome, are associated with normal cake icing in bakeries. Thus, a machine for this purpose, such as the present invention, can increase productivity, cake product quality and uniformity, and significantly reduce icing consumption and waste, but more importantly, can protect the health and welfare of bakery workers.

### DISCUSSION OF THE PRIOR ART

Numerous examples of cake icing machines, as well as cake decorating machines, are found in the prior art. U.S. Pat. No. 2,481,242 teaches a mechanically controlled machine dispensing icing onto round cakes as they rotate on a pedestal. The icing is dispensed from a pressurized reservoir by the force of the gas pressure applied to it.

U.S. Pat. No. 2,553,191 discloses an electromechanical design for rotating a round cake while icing is dispensed and deposited simultaneously onto the side and top of the cake from two pressurized icing reservoirs. This patent also discloses use of separate blade-like spreaders to smooth and distribute the deposited icings.

U.S. Pat. No. 5,209,779 shows an icing spreader for the manual production of decorated patters on cakes.

U.S. Pat. No. 5,505,775 discloses a cake decorating system with automated cake positioning with a motion controlled travelling arm dispensing colored icings to create decorated images on a cake.

U.S. Pat. No. 5,795,395 teaches a cake decorating machine with a pivot head dispensing edible colorants corresponding to the pixels of a digitized image.

U.S. Pat. No. 6,460,481 discloses a cake decorator consisting of a hand held motor driven piston dispenser for placing beads of icing onto cakes.

U.S. Pat. No. 4,043,294 discloses a machine for applying icing only onto the vertical sides of round cakes on an automatic basis. The invention shows icing supplies to a positive shut-off annular slit nozzle by a positive displacement gear pump from a conical reservoir located somewhat remote from the infeed of the pump. Pump RPM is controllable to allow “the pump to operate at as low a discharge pressure as possible”. A clutch-brake mechanism controls pump motion.

U.S. Pat. No. 6,390,662 discloses “A cake and pastry decorating system incorporating a hand-held icing mixing wand having a mixing chamber and a dispensing nozzle. Base icing is supplied to the mixing chamber and one or more colorants are selectively supplied through a flexible hose to the mixing chamber. Icing is dispensed from the mixing chamber through the dispensing nozzle directly on the cake or pastry in patterns determined by the position of the hand-held icing mixing wand and shape of the dispensing nozzle. “(Abstract)The specification of this patent also discloses the use of a “a base icing storage vessel 10, preferably pressurized, by means of a pneumatic cylinder 11 forcing a nylon plate 12 against the upper surface of a flowable base frosting 13 (typically white icing). Since the base icing may be viscous, a positive displacement pump 14 which, when activated, forces the base frosting to a hand-held and maneuvered wand 15 and application and mixing head 15H. ” The positive displacement pump is specified as a “lobe pump” or alternatively as a “screw pump”.

### OBJECTS AND SUMMARY OF THE INVENTION

The invention present provides for the use of a forced feed arrangement feeding icing into a sanitary design rotary motion pump, and particularly a sanitary gear pump. When suitably driven at a desired and stable rotation speed, icing is delivered to a point of application (POA) at a desired flow rate and at a uniform and relatively invariant flow rate. The icing flow from the machine can be started and stopped at will by an operator, and numerous design features assure ergonomic and safe machine operation.

The machine is a self-contained and portable and is capable of operation with all known frostings, icings and fondants. Various unique and novel features combine to enhance ease of operation and the icing product flow pathway is particularly designed to ease and speed cleaning.

By use of the particular forced feed arrangement disclosed herein, in conjunction with the use of a positive displacement sanitary pump with symmetrical displacement rotors, icing can be reliably metered in a uniform way, free of the flow interruptions and variations caused by pump cavitation at its infeed or by flow stoppage at its discharge, both conditions resulting from pumping viscous icings full of gas pockets.

By a listing of the objects of the present invention, its unique and novel aspects can be summarized and understood unto themselves, and in comparative reference to the prior art. Thus, the objects of invention include:
1. To disclose a unique baked goods icing applicator machine capable of placing icing over the exposed surfaces of any pastry, and most particularly a cake, of any shape.
2. To disclose a unique icing applicator machine which is entirely self-contained in terms of its functional parts, save for its utility requirements.
3. To disclose a unique icing applicator machine which is portable as a roll around unit, and capable of being easily moved by only one person of average stature and strength.
3A. To disclose a unique and novel icing applicator machine which is built close to floor level in order to facilitate and provide easy access to the top of the icing reservoir thus allowing easy periodic loading of the reservoir with icing by workers of average stature and strength.
4. To disclose a unique icing applicator machine in which a gear pump meeting 3A sanitary standards is utilized and in which the pump is directly driven in servo mode by the servo drive train, which consists of a servo motor directly coupled to an in-line helical gear reducer, in turn directly coupled to the pump.
5. To disclose a unique icing applicator machine in which the icing reservoir is readily removable from the machine without use of tools, for the purpose of ease of cleaning or exchange with a like reservoir containing a different type of icing.
6. To disclose a unique icing applicator machine which provides for a vertical mast for the purpose of supporting a horizontal extension beam, both of which support the icing flow pathway between the discharge of the icing pump and the point of icing deposit, thus allowing ease of machine positioning and use in many varied settings and layouts.
7. To disclose a unique and novel icing applicator machine in which the icing flow pathway from the discharge point of the icing pump to the end of its vertical rise is constructed of rigid material, typically stainless steel, for the express purpose of enhancing durability in the intended use of the machine, and for the second express purpose of eliminating the distension evident in flexible tubes when subjected to substantial interval pressure. This particular element of the invention largely eliminates the peristaltic-like flow displacement effect created when flexible tubing distended or enlarged by high pressure flow deflates or rebounds to its initial dimensions at the start of an icing application flow event.
8. To disclose a unique and novel icing applicator machine in which the rigid portion of the icing flow discharge pathway is segmented into separable shorter length sections for the express purpose of allowing ease of hand cleaning and inspection. The shorter sections are typically fastened one to the next using sanitary connectors, most typically tri-clamp connections.
9. To disclose a unique and novel icing applicator machine in which the rigid icing flow outfeed is attached to the vertical mast using the same type of sanitary connectors used to assemble the outfeed sections.
10. To disclose a unique and novel icing applicator machine in which the entire icing flow pathway, including all icing contact points, can be readily hand removed from and re-assembled to the machine without the use of any tools.
11. To disclose a unique and novel icing applicator machine in which the length of each vertical outfeed tube section is the same as all others, thus aiding simple and easy re-assembly.
12. To disclose a unique and novel icing applicator machine in which the preferred pump embodiment is a CleanGear® pump as taught by Phallen et al in U.S. Pat. No. 6,808,374.
13. To disclose a unique and novel icing applicator machine in which the horizontal extension boom can be readily pivoted about in an arc about the vertical mast in order to allow ease of positioning of the icing dispense nozzle to the convenience of the machine operator.
14. To disclose a unique and novel icing applicator machine in which the vertical mast may be height adjusted to accommodate the requirements of the facility where used.
15. To disclose a unique and novel icing applicator machine in which the horizontal extension boom can be adjusted in length to accommodate the requirements of the facility where used.
16. To disclose a unique and novel icing applicator machine in which the icing reservoir has a bottom break or cone section in order to facilitate flow of icing into the icing pump and to facilitate reservoir cleaning.
17. To disclose a unique and novel icing applicator machine in which the centered outfeed port fitting on the bottom of the icing reservoir is only as long as is required to allow a clamp to be fitted to couple the reservoir port to the pump port, this being done to minimize the flow resistance of icing from the reservoir into the pump.
18. To disclose a unique and novel icing applicator machine in which the pump in-feed port is particularly oriented vertically to the reservoir outfeed port, for the express purpose of minimizing the distance between the bottom of the reservoir and the in-feed of the pump, thus minimizing the flow resistance of this part of the icing fluid flow pathway.
19. To disclose a unique and novel icing applicator machine in which the icing reservoir is located directly above and centered on the icing pump for the express purpose of allowing a gravity feed arrangement into the pump in order to foster icing flow into the pump.
20. To disclose a unique and novel icing applicator machine in which the rigid outfeed section is connected to the icing dispense nozzle by a length of suitable flexible sanitary tubing, the length being of the minimal dimension allowable to provide suitable articulation of the nozzle for its intended purpose.
21. To disclose a unique and novel icing applicator machine in which the extension boom is provided with a counter balance pulley thus allowing a machine operator to easily and readily move the icing dispense nozzle vertically as required for use at any desired table or counter or work surface, and allowing the nozzle to retract upward out of the way of the work surface when not in use.
22. To disclose a unique and novel icing applicator machine capable of icing all exposed surfaces of a cake measuring 20 inches by 12 inches by 3 inches to an average depth of icing of 0.25 inches in 30 seconds or less, this constituting a flow rate of icing of about 1 gallon per minute (US).
23. To disclose a unique and novel icing applicator machine in which icing is forced to the pump in-feed by use of a ram disk locatable within the icing reservoir.
24. To disclose a unique and novel icing applicator machine in which the ram disk serves as a carrier and backer plate for a flexible single convolution beaded peripheral circumferential seal element, the seal being pressure activated by mechanical contact with the top of icing in the icing product reservoir.
24A. To disclose a unique and novel icing applicator machine in which the single convoluted shape of the circumference seal element allows the unloaded seal diameter to be smaller than the icing reservoir internal diameter, thus permitting easy insertion of the seal into and withdrawal from the reservoir, while still allowing sealing to occur against the reservoir wall as a result of seal diameter increase as the single convolution of the seal is forced against the icing reservoir wall by the ram disk.
25. To disclose a unique and novel icing applicator machine in which the ram disk seal assembly can be raised away from or lowered into close proximity to the upper lip of the icing reservoir by use of a motion controlled pneumatic cylinder.
26. To disclose a unique and novel icing applicator machine in which the ram disk, in its raised position away from the reservoir can be freely pivoted by hand about the axis of the raising cylinder, thus allowing free and unimpeded access to the reservoir for loading with icing or for removal or for cleaning in situ.
27. To disclose a unique and novel icing applicator machine in which the ram disk in its lowered position is securely positioned and fixed just above the upper lip of the reservoir by use of at least two handle-operated locking clamps, the clamps fixing a ram disk mounting cross bar to the reservoir mounting frame.
28. To disclose a unique and novel icing applicator machine in which each ram disk mount bar locking clamp is fitted with a sensor which detects the position of each clamp as locked or unlocked.
29. To disclose a unique and novel icing applicator machine in which force cannot be applied to the ram disk and hence against icing in the reservoir unless all clamps are in a locked position as determined by the mount bar locking clamp sensors, thus assuring safe machine operation.
30. To disclose a unique and novel icing applicator machine in which the ram disk cannot be raised up away from the icing reservoir by the ram dick position cylinder unless all clamps are in an unlocked position as determined by the mount bar locking clamp sensors, thus assuring safe machine operation.
31. To disclose a unique and novel icing applicator machine in which the ram disk mount bar locking clamp sensors serve as interlock sensors, assuring that the ram disk is first oriented concentrically with the bore of the reservoir, thus assuring that the subsequent entry of the disk into the reservoir will occur without the possibility of peripheral seal damage caused by misalignment of the disk with the bore of the reservoir.
32. To disclose a unique and novel icing applicator machine in which the mechanical position and arrangement of the ram disk position cylinder causes the ram disk and seal assembly to be mechanically stopped just above the upper edge of the icing reservoir when the disk is fully lowered by the ram disk position cylinder. When the ram disk and seal assembly are mechanically stopped in this fully lowered position, the assembly is in such close proximity to the top of the reservoir that when the disk is hand oriented or rotated such that it is concentric with the icing reservoir bore, it is not physically possible for a person's fingers to freely pass between the space between the edge of the disk and the rim of the reservoir. As a result of this arrangement, only when the ram disk mount bar locking clamp sensors are detected as locked, and thus confirm that the ram disk and seal assembly is concentric with the reservoir and in close mechanically defined “finger safe” proximity to the icing reservoir lip is it possible for the disk to be further lowered by the air ram thrust cylinder to actually enter into the bore of the reservoir, thus assuring safe machine operation.
32A. To disclose a unique and novel icing applicator machine in which the ram disk assembly cannot be lowered by the ram disk position cylinder unless the ram disk thrust cylinder is fully retracted as indicated by the ram disk thrust cylinder full retract position sensor, thus assuring that the ram disk assembly, when lowered, is correctly positioned in “finger safe” proximity to the icing reservoir lip, thus assuring safe machine operation.
32B. To disclose a unique and novel icing applicator machine in which the ram disk assembly cannot be raised away from the rim of the icing reservoir by the ram disk position cylinder unless the machine controller detects that the air ram thrust cylinder full retract position sensor is made, and unless the machine controller detects that the all air ram mount bar locking clamp sensors are unmade, thus assuring safe machine operation.
33. To disclose a unique and novel icing applicator machine in which the force applied to the ram disk is determined and limited by an air ram thrust cylinder such that the diameter of the air ram cannot be more than one fourth that of the icing reservoir diameter (a ratio of 1:4). This ratio assures that even with 200 psi of air pressure applied to the air ram thrust cylinder, a pressure far in excess of that typically available from air compressors used in bakeries, a maximum of only about 12.5 psi of pressure can be applied by the ram disk against the icing in the reservoir, thus assuring safe machine operation.
34. To disclose a unique and novel icing applicator machine in which the mechanical stroke of the air ram thrust cylinder is particularly determined relative to the ram disk and the icing reservoir such that the circumference of the ram disk seal cannot be extended beyond the end of the cylindrical portion of the reservoir, thus assuring that the seal cannot be damaged by being pinched between the ram disk backer plate and the reducing diameter of the bottom conical section of the reservoir.
35. To disclose a unique and novel icing applicator machine in which the stroke of the air ram thrust cylinder is particularly determined relative to the ram disk and the icing reservoir to assure that the ram disk can be extended to the lower end of the cylindrical portion of the reservoir for the express purpose of being able to force icing from the hopper as the icing level decreases down to the lower end of the concentric section of the reservoir.
36. To disclose a unique and novel icing applicator machine in which the ram disk-peripheral seal is positioned and retained to the ram disk backer plate by a peripheral seal retainer, the shape of the retainer being generally conical such that its cone angle matches the conical bottom of the reservoir. This arrangement allows the conical peripheral seal retainer to extend into the conical bottom portion of the icing reservoir when the ram disk is fully extended down into the reservoir, thus allowing the ram disk to displace nearly all of the icing contained within the reservoir.
36A. To disclose a unique and novel icing applicator machine in which the icing displacement cone serving as the peripheral seal retainer also serves as a self-guiding structure helping to center the ram disk assembly over the reservoir as it is lowered by the ram disk position cylinder.
37. To disclose a unique and novel icing applicator machine in which the air ram thrust cylinder is provided with a fully retracted position sensor thus allowing the machine controller to detect this position for control and sequence interlock purposes; and in which the air ram thrust cylinder is provided with a fully extended position sensor thus allowing the machine controller to detect this position for control and sequence interlock purposes.
38. To disclose a unique and novel icing applicator machine in which the ram disk thrust cylinder, when fully retracted, maintains the air ram disk backer plate at least 1.5 inches (4 centimeters) away from the undersurface of the air ram mount bar, thus assuring that hands or fingers cannot be pinched or injured in this area of the machine.
39. To disclose a unique and novel icing applicator machine in which air pressure is applied only to the lift side of the ram disk position cylinder through two redundant fixed flow orifices for the purpose of slowing and limiting the rate of extension motion and the rate of retraction motion of the icing reservoir ram disk assembly, thus assuring safe machine operation.
40. To disclose a unique and novel icing applicator machine in which the ram disk assembly is lowered into close proximity to the icing reservoir rim only by the force of gravity as air is slowly exhausted from the lift side of the ram disk position cylinder and not by any additional applied pneumatic force, thus assuring safe machine operation.
41. To disclose a unique and novel icing applicator machine in which a vacuum breaker valve is fitted to the bottom cone portion of the icing reservoir such that, prior to activation of the ram disk thrust cylinder to raise the ram disk assembly to the top of the reservoir, the valve is opened, allowing air to flow into the reservoir below the ram disk, thus assuring that atmospheric pressure is maintained on both sides of the disk as it is raised.
42. To disclose a unique and novel icing applicator machine in which the vacuum breaker valve is manually operated, with an interlock sensor such that raising of the ram disk is not allowed by the machine controller unless the sensor confirms that the valve is first opened, and such that applying thrust to the ram disk is not allowed by the machine controller unless the sensor confirms that the valve is first closed.
43. To disclose a unique and novel icing applicator machine in which the vacuum breaker valve is automatically actuated, such that the valve is closed by the machine controller before ram disk thrust can be applied, and is opened by the machine controller before the ram disk can be withdrawn from the reservoir.
44. To disclose a unique and novel icing applicator machine in which the vacuum breaker valve can be a sanitary check valve operating automatically based on differential pressure such that raising of the ram disk opens the valve and thrusting of the ram disk closes the valve.
45. To disclose a unique and novel icing applicator machine in which the icing reservoir may be automatically refilled without removal of the ram disk assembly from the reservoir by forcing icing into the reservoir from another source using a fitting in the reservoir for this purpose and using the ram disk thrust cylinder sensors for reservoir level control purposes.
46. To disclose a unique and novel icing applicator machine in which the icing pump drive is interlocked via the machine controller such that the drive is inoperable when the ram disk assembly is fully extended into the icing reservoir.
47. To disclose a unique and novel icing applicator machine provided with a fast acting positive shut-off valve located at the end of the rigid vertical icing flow discharge pathway and before the flexible product feed tube, the valve providing high pressure shut-off of icing flow, thus assuring immediate icing flow stoppage when the icing pump is stopped, and doing so without adding the mass of the valve to the moveable portion of the icing dispense nozzle, thus enhancing the ergonomics of the machine.
48. To disclose a unique and novel icing applicator machine in which a fast acting positive shut-off valve located at the end of the rigid vertical icing flow discharge pathway assures immediate initiation of icing flow when the icing pump is rotated, the valve maintaining the gas filled icing in a compressed and pressurized condition between icing flow events, thus eliminating the flow latency period that is evident without such a valve.
49. To disclose a unique and novel icing applicator machine in which the fast acting positive shut-off valve is position encoded using a sensor on the valve actuator, such that it is interlocked via the machine controller such that the valve must be in an open condition for icing pump mediated flow to occur.
50. To disclose a unique and novel icing applicator machine in which compressed air pressure to the machine is monitored by a sensor such that the machine will not operate if requisite pressure is not available.
51. To disclose a unique and novel icing applicator machine in which the compressed air regulators controlling pressure to the various pneumatic actuators of the machine are located inside of the machine cover, thus being relatively inaccessible, thus being resistant to tampering or adjustment.
52. To disclose a unique and novel icing applicator machine in which a sanitary gear pump is utilized for icing displacement for the express purpose of establishing the non-pulsitive flow required for effective cake icing. Because viscous cake icings are filled with persistent gas inclusions as a result of mixing and handling, other pump types cause flow to be irregular and highly variable. The gear pump structure, because of its relatively small displacement per increment of rotation and because of its highly linear flow integration characteristics, overcomes these problems.
53. To disclose a unique and novel icing applicator machine in which a low flow resistance in-feed structure to the icing pump is used in conjunction with a gear pump such that air inclusions located at the in-feed of the pump can be displaced to the pump outfeed even when the outfeed is at relatively high pressure, thus overcoming a stall or no flow condition known as an air bound pump.
54. To disclose a unique and novel icing applicator machine in which the long discharge pathway from the pump to the icing dispense nozzle necessitated by the ergonomics layout of the machine requires high pressure in the discharge pathway, typically above 100 psi, to achieve the icing flow rate required for rapid icing of a cake.
55. To disclose a unique and novel icing applicator machine in which the icing dispense nozzle is freely manipulatable and easily moved as desired by the machine operator and does not require motions that are associated with repetitive stress syndromes.
56. To disclose a unique and novel icing applicator machine in which the icing dispense nozzle has only a small low pressure shut-off valve integrated into its structure, thus allowing the nozzle to be relatively light and easy to manipulate, the valve serving only to prevent drip or ooze of icing at the nozzle.
57. To disclose a unique and novel icing applicator machine in which the icing dispense nozzle has an icing flow on-off switch integrated with the low pressure shut-off valve, thus integrating high pressure pumping and the fast acting high pressure positive shut-off valve with the low pressure nozzle valve.
58. To disclose a unique and novel icing application machine in which the icing dispense nozzle also serves for the spreading and smoothing and distribution of the icing coincident with the application of the icing from the nozzle by the machine without the requirement for a separate spreader device or tool. The icing is spread and distributed and smoothed generally with the same motion used to apply the icing to the cake and the icing dispense nozzle can be utilized in a non-flowing condition for spreading as well.
59. To disclose a unique and novel icing applicator machine in which icing can be delivered onto cakes and pastries at comparatively high flow rates and at high pumping pressures without degradation of the icing or alteration of its texture or properties or characteristics.

### BRIEF DESCRIPTION OF THE FIGURES

FIG. 1 is a side elevational view of the apparatus of the present invention for applying icing or the like to baked goods, such as cakes

FIG. 2 is a simplified tip view of the apparatus shown in FIG. 1 with the parts being shown in the loading position.

FIG. 3 is a view similar to FIG.2 with the parts being shown in the position they would occupy when icing is being forced from a reservoir onto a cake or the like.

FIG. 4 is a view similar to FIG. 1, but showing the air ram disk in a raised retracted position.

FIG. 5 is a detail showing the ram disk assembly.

FIG. 6 is a machine detail showing dual fixed orifice flow controls limiting motion rate of ram disk position cylinder.

FIG. 7 is a detail view showing the ram disk mount bar locking clamp and position sensor.

FIG. 8 is a machine detail showing a modified icing reservoir provided with an automatic refill reservoir port.

FIGS. 9A and 9B side and front views of the icing dispensing nozzle.

FIG. 10 is a front view of the apparatus shown in FIG. 1

FIG. 11 is a side view of a 3A sanitary gear pump.

FIG. 12 is a top sectional view of the pump shown in FIG. 11.

### DETAILED DESCRIPTION

The icings used on many cakes consist principally of sugar, various fats and oils, colorings and flavorings, all combined in a mixer to create a relatively homogeneous mixture. In most bakery settings, icings are often mixed on site as needed. The mixers used are efficient and effective, but result in icings with large numbers of air inclusions (air pockets, air vacuoles, air bubbles) that are highly variable in size and distribution. Further handling of these icings, by transfer to other vessels for example, adds still more air inclusions. Because the icings are of necessity viscous and generally not free flowing, these described air inclusions are persistent and do not dissipate. Further, icings are known to separate and change consistency with mechanized handling, particularly with pumping. Thus, significant problems are presented in devising a more automated icing dispensing machine for covering or icing cakes and the like.

Because of these rheology problems with icings and frostings, effective icing applicator machines for use in bakeries have not been successfully developed. Essentially, applying icings onto a cake for example, requires being able to establish a flow rate of icing that is as substantially as desired and which is essentially invariant during the application process. This represents a liquid metering process, and the present invention provides an economical and practical means to meter icings thus allowing them to be applied to cakes and pastries without difficulty.

Further, because the invention provides controlled and predicable icing flow, the machine can also dispense icing on a defined dose basis in addition to its flow on demand capability. When used in dose mode, the machine controller operates the pump on a timed flow basis or based on total pump rotation as measured by an incremental encoder.

In its preferred embodiment, the machine of the present invention consists of a portable and self-contained machine frame constructed to sanitary standards and requirements, a servo-gear reducer pump drive train, a precision sanitary gear pump, a rigid outfeed terminating in a high pressure fast-acting shut-off valve, a ram disk icing feed and reservoir directly coupled to the pump, a vertical mast supporting a horizontal boom allowing easy positioning and use of an icing dispensing nozzle with an integrated shut-off valve and start/stop switch, a machine controller of conventional nature, and necessary pneumatic components, mostly of conventional nature.

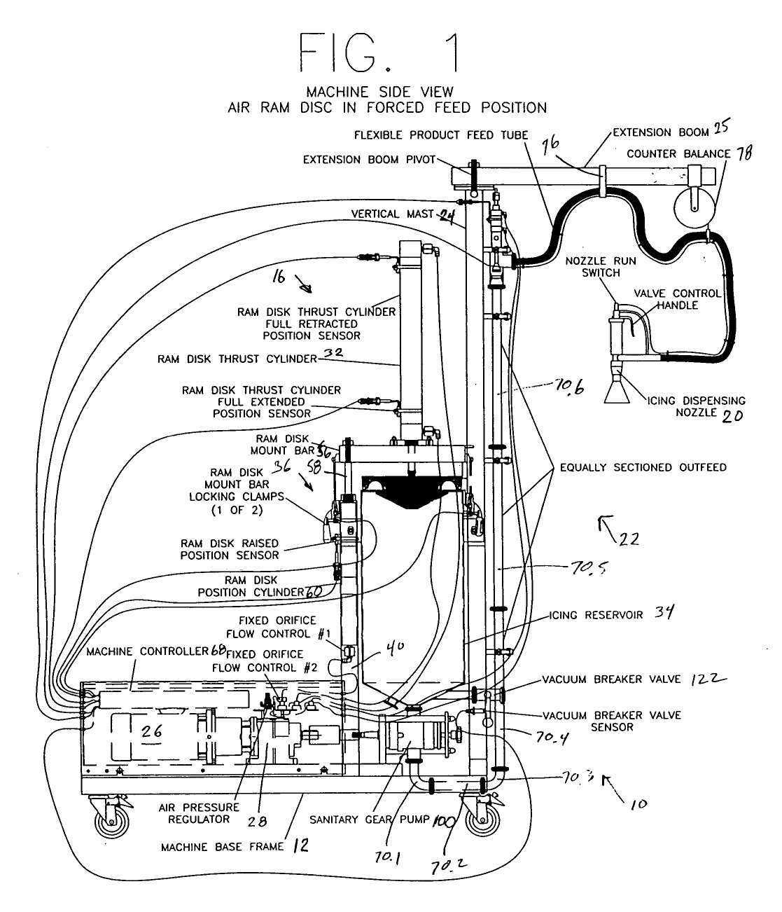

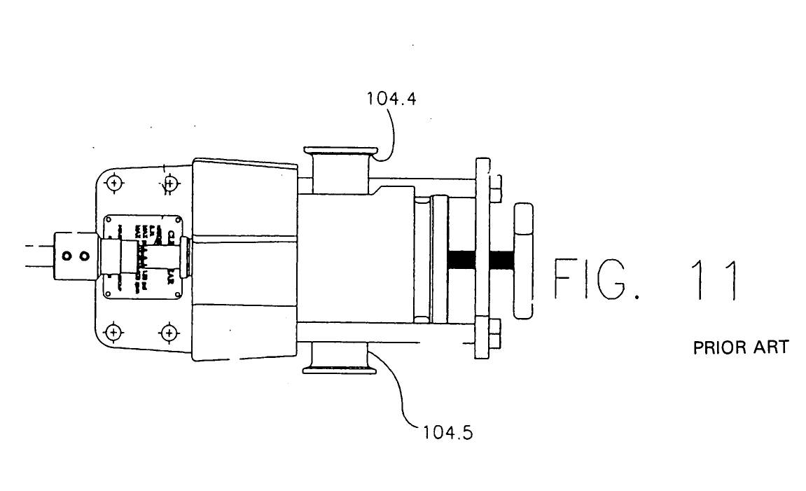

The foregoing apparatus, which is indicated generally at 10, is best shown in FIGS. 1, 4, and 10 and includes a wheeled machine base 12 which supports a positive displacement sanitary design gear pump 100 which meets 3A sanitary standards, means, indicated generally at 16, for force feeding icing into the inlet port 104.1 (FIG. 11) of the pump, an icing dispensing nozzle 20, and means, indicated generally at 22, for establishing an icing flow pathway which extends from the outlet port 104.2 of the pump to the icing dispensing nozzle. The icing flow pathway is supported by a vertical mast 24 and a horizontal boom forming a pivoted extension beam 25.

The pump 100 is directly driven in servo mode by the servo drive train, which consists of a servo motor 26 directly coupled to an in-line helical gear reducer 28, the motor and gear reduced both being mounted on the wheeled machine base 12 to one side of the pump, and are connected thereto in a conventional manner.

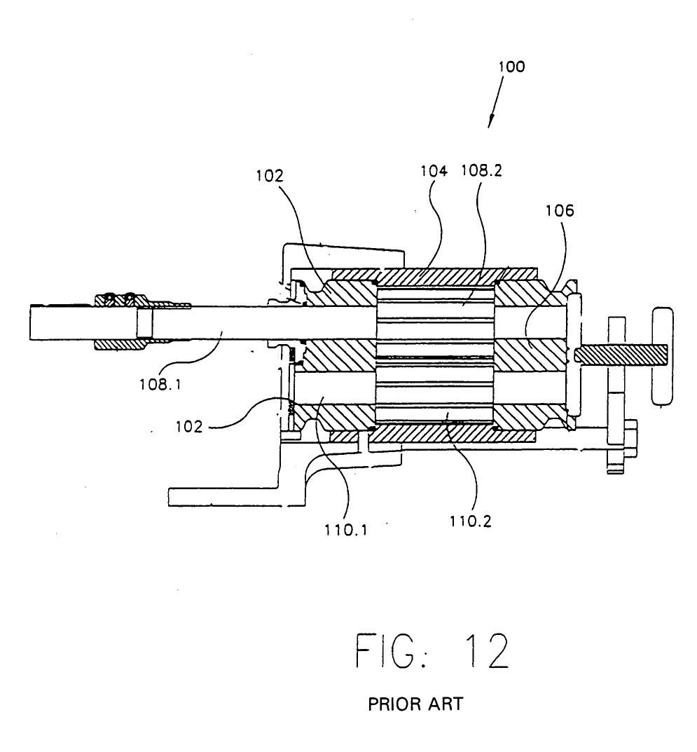

With reference now to FIGS. 11 and 12, the pump 100 includes a housing 104 having a pump body bore extending from one end of the housing to the other end of the housing. The housing is further provided with an infeed port 104.4 and an outfeed port 104.5. Two spaced apart gear shaft bearing blocks 102, 106 are mounted within the pump body bore, each block extending outwardly of the pump housing. Each of the bearing blocks including a pair of gear shaft support bearing holes. Symmetrical displacement rotor assemblies 108, 110 are mounted within the housing, the rotor assemblies being a drive gear assembly 108 and an idler gear assembly 110 disposed within the pump body bore, the drive and idler gear assemblies including gear shafts 108.1, 110.1 which extend through the gear shaft bearing holes, and meshing drive and idler gears 108.2, 110.2 mounted between the ends of the shafts. The foregoing is more fully described in U.S. Pat. No. 6,808,374.

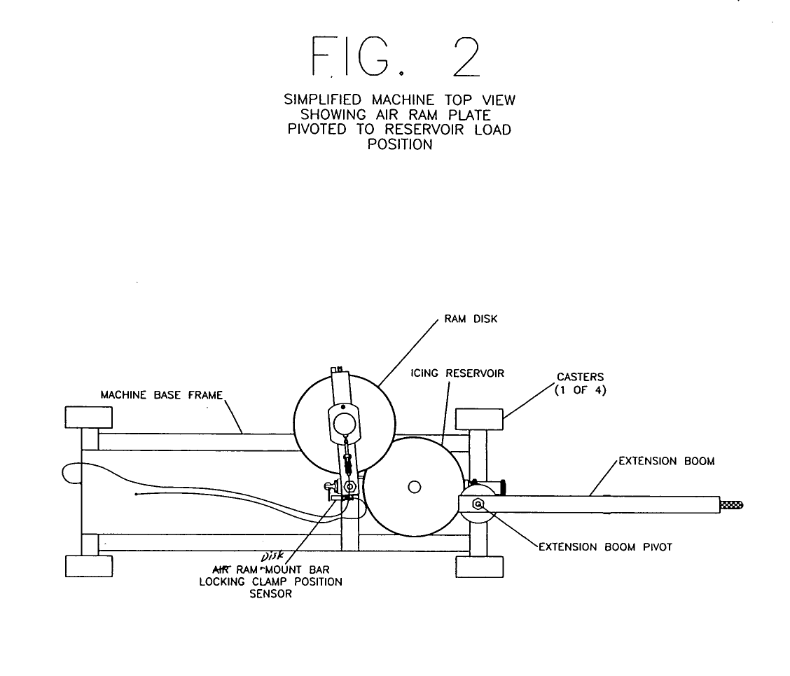

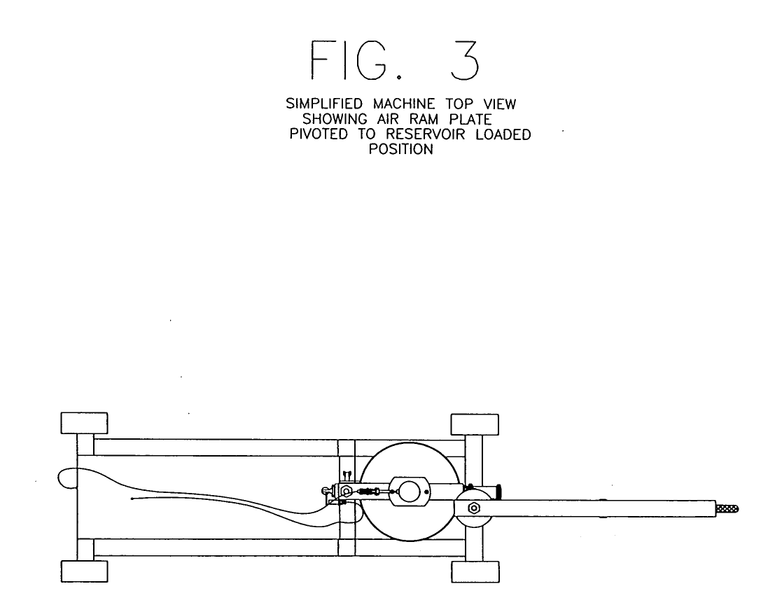

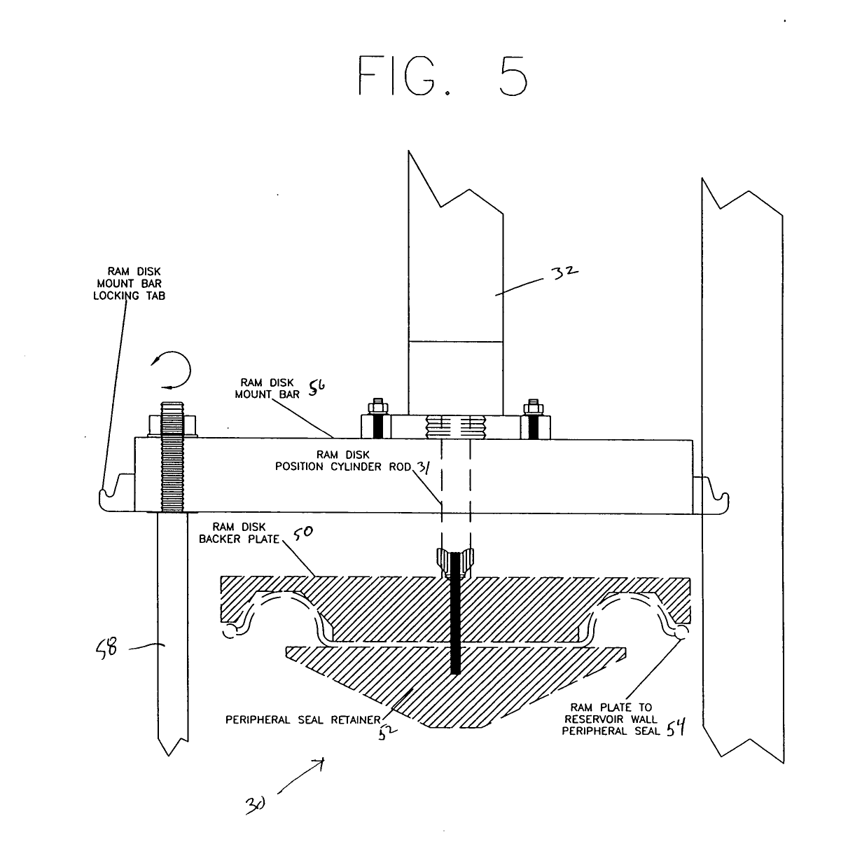

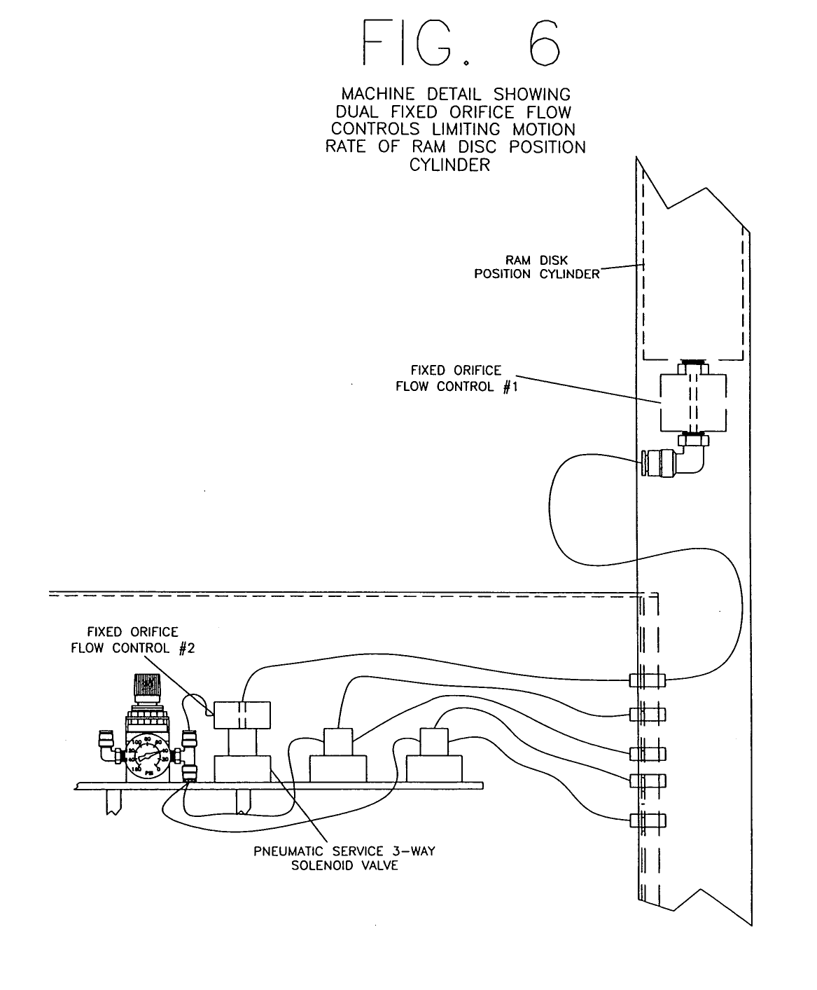

With reference now to FIGS. 1-8 and 10, the means 16 to force feed icing into the sanitary pump include a ram disk assembly 30 (FIG. 5) carried by the rod 31 of a motion controlled pneumatic cylinder assembly (or ram disk thrust cylinder) 32 for raising and lowering the ram disk assembly, and an icing reservoir 34, the ram disk assembly being locatable within the reservoir. Means 36 are provided for raising and lowering the pneumatic cylinder 32, so that the ram disk assembly can be raised entirely above the reservoir and then be swung to one side.

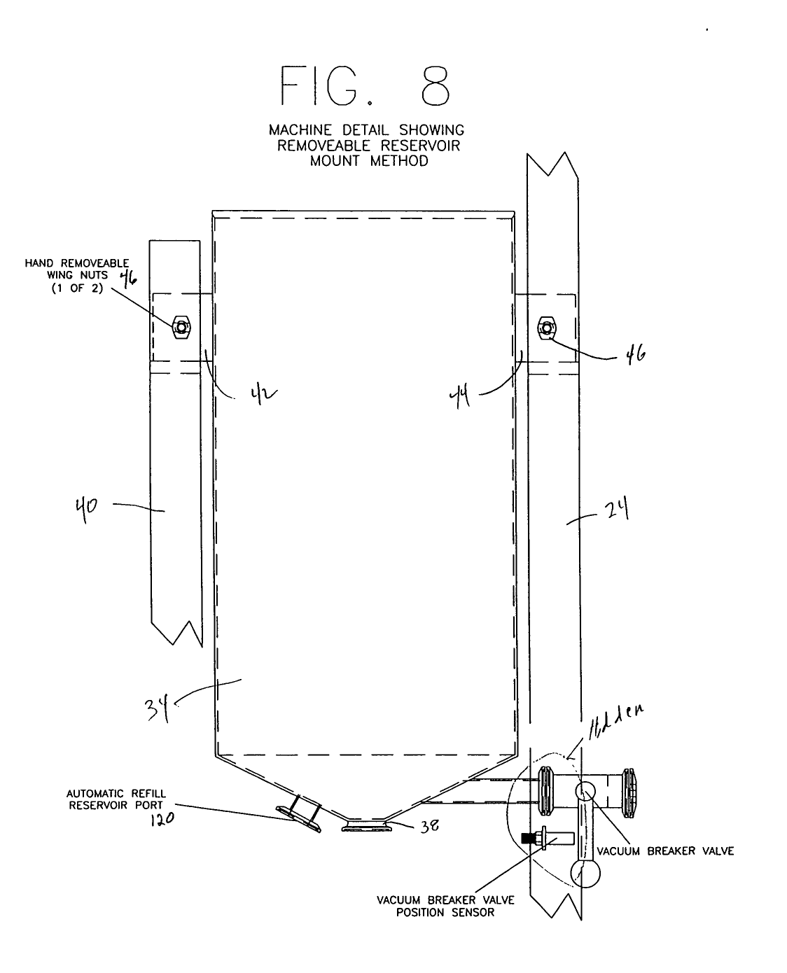

The reservoir is generally cylindrical, although a bottom portion (best shown in FIG. 8) is conical. An outfeed port 38 is located at the bottom of the conical portion, which is coupled directly to the inlet port 104.1 of the pump by a sanitary connector.

It should be noted at this point that all components of the apparatus of the present invention which come into contact with the icing must meet sanitary standards. To this end, the reservoir, which is preferably made of stainless steel can be easily removed for cleaning. To this end, the outlet port of the reservoir is coupled to the infeed port by a sanitary connector. The reservoir is supported on the machine frame by the vertical mast 24 which supports the vertical section of the icing flow pathway and by a further intermediate vertical mast 40. Thus, as can best be seen from FIG. 8, the reservoir is provided with opposed ears 42, 44 which are secured to the masts by suitable studs and wing nuts 46.

The ram disk assembly, as can best be seen from FIG. 5, includes a ram disk backer plate 50, a conical peripheral seal retainer 52, and a circular flexible one convolution beaded peripheral circumferential seal element 54. The conical seal retainer 52 has the same cone angle as the bottom of the reservoir to assisting in forcing out icing from the reservoir.

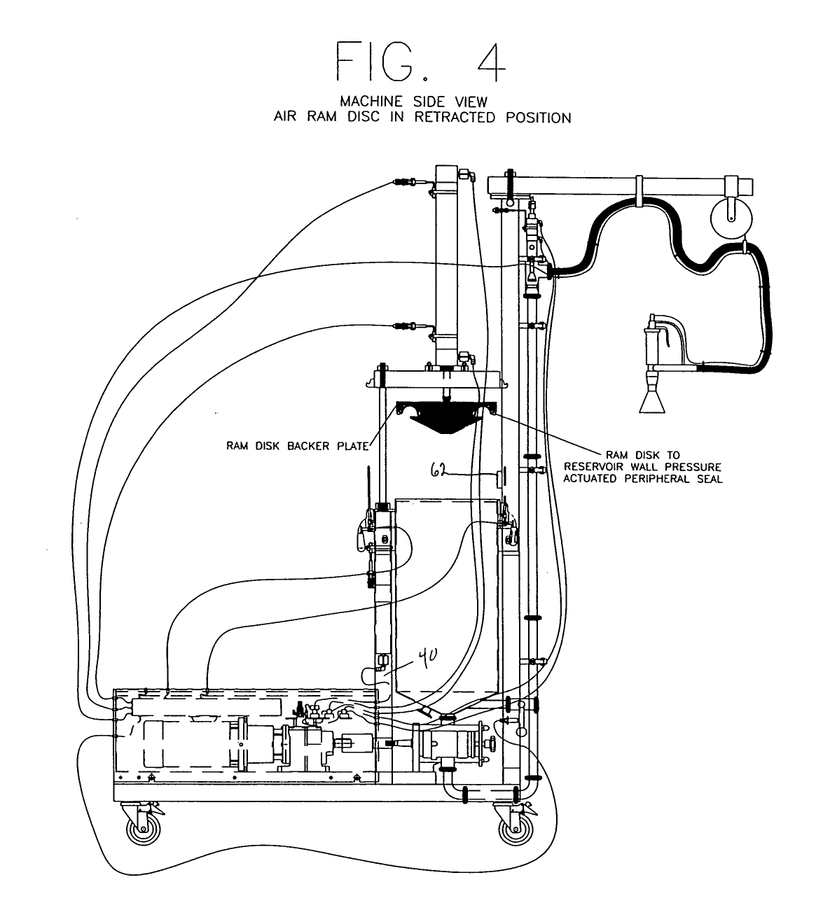

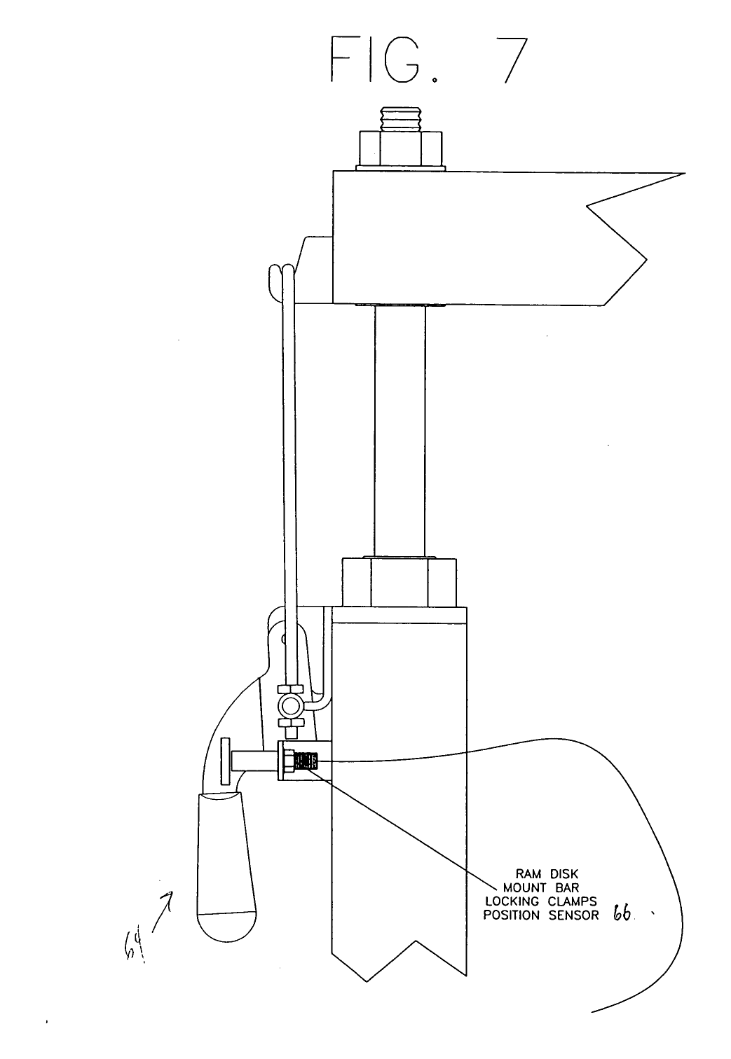

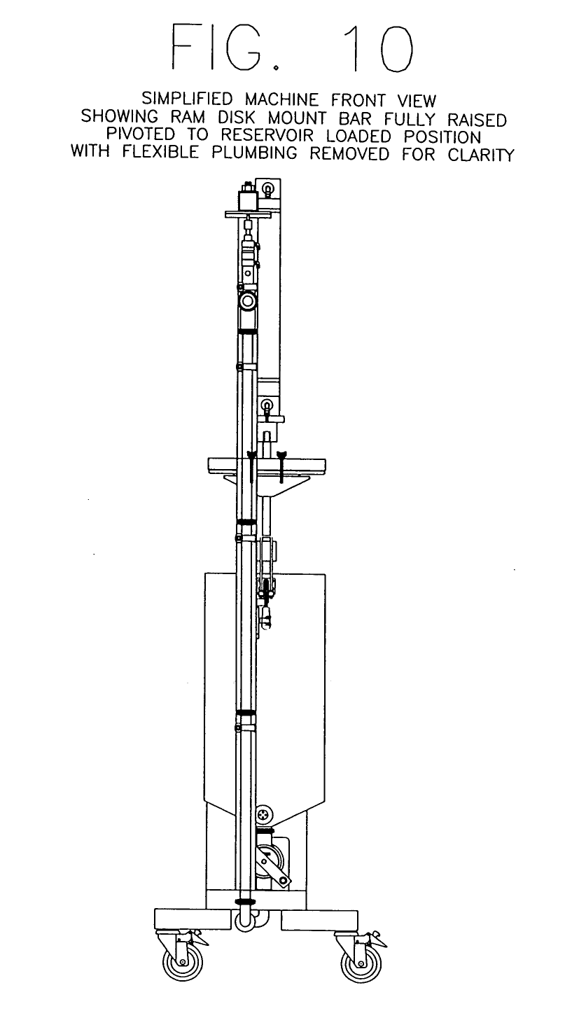

As previously noted, the apparatus is provided with means 36 for raising and lowering the pneumatic cylinder 32, so that the ram disk assembly 30 can be raised entirely above the reservoir and then be swung to one side. This means includes a ram disk mount bar 56 which is carried by piston rod 58 which extends outwardly of a ram disk position cylinder 60 mounted on the intermediate mast 40. The ram disk thrust cylinder 32 is mounted on the mount bar 56. The pneumatic cylinder is shown in its fully raised positions in FIGS. 4 and 10, and in its lowered position in FIG. 1. In the lowered position the ram disk position cylinder rod 56 will be bottomed out, and the opposite side of the ram disk mount bar 56 will come into contact with a stop 62 carried by the vertical mast 24 at the right side of the machine as viewed in FIG. 1. The ram disk mount bar will be secured in its lowered position by a pair of hand operated ram disk mount bar locking clamps 64, one of which is best shown in FIG. 7. Ram disk mount bar locking clamp position sensors, which are interconnected with a machine controller, will determine when the clamps are locked (or unlocked) thus insuring that force cannot be applied to the ram disk thrust cylinder until the ram disk mount bar is locked place.

The means for establishing an icing flow pathway from the discharge of the pump to the nozzle assembly includes a rigid icing flow pathway in the form of stainless steel tubes 70, a relatively short length of flexible tubing 72, and a past acting positive shut-ff valve 74. The rigid icing flow pathway consists of relatively short lengths of stainless steel tubing which are connected to each other by sanitary connectors. Thus, there is an elbow 70.1 connected to the outlet port of the pump 100, a short length of horizontal tubing 70.2, another elbow 70.3, and, as shown, three equal lengths sections of vertical tubing 70.4, 70.5, and 70.6 which are supported by the mast 24. All sections are connected to each other by sanitary connectors. At the upper end of the rigid vertical section is the fast acting positive shut-off valve 74, such as the type shown in the Oden Corporation product literature for its GEN2 Positive Shut-Off Nozzle. The relatively short flexible product line is supported by the extension boom via straps 76, one of which is supports a counterbalance 78.

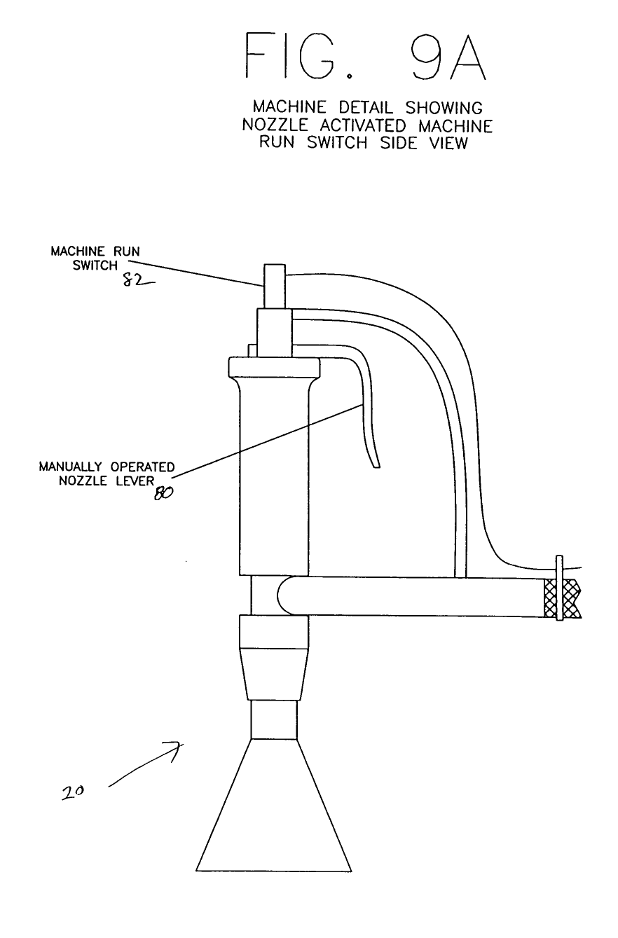

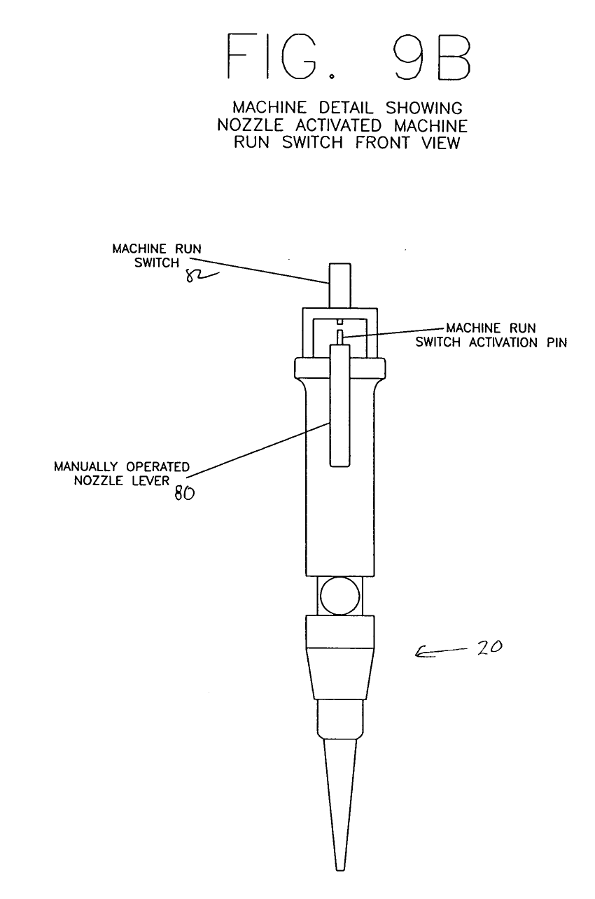

The nozzle is best shown in FIGS. 9A and 9B and includes an internal small low pressure shut-off valve (not shown). The operation of the valve is controlled by a icing flow on-off switch or lever 80. When the lever is moved from its normal at rest position shown in FIG. 9A, it will simultaneously open the low pressure shut-of valve, and also, through the operation of switch 82, cause the high pressure shut-off valve 74 to be opened, to initiate operation of the pump 100, and initiate the operation of the associated means for force feeding the pump. Similarly, when the lever is released, it will move back to its normal position shown in FIG. 9A, causing the low pressure valve to close, and again, through the operation of the switch 82, shut down icing flow.

The invention will be best understood by a brief description of its use and operation.

The machine is loaded with icing by raising the ram disk to a position above the upper rim of the reservoir, as pictured in FIG. 4. In this position, the interior of the reservoir is readily accessible. The disk is raised using the ram disk position cylinder which extends to the full length of its travel. In this fully extended position, a ram disk raised position sensor confirms this position to the machine controller, which is typically a PLC or microcontroller. In the fully extended position the ram disk assembly (consisting of the ram disk backer plate, the reservoir wall peripheral seal, and the peripheral seal retainer) can be freely pivoted about the ram disk position cylinder rod, thus providing unimpeded access to the reservoir for manual loading of icing, which is typically accomplished using a sanitary scoop or shovel or pail or bowl. The reservoir is typically designed to hold 5 to 15 gallons (US) of icing, which is typically sufficient to fully cover 30 to 50 cakes in icing, depending on applied thickness or depth.

During loading, the ram disk thrust cylinder is fully retracted and its position is confirmed to the controller by the ram disk thrust cylinder full retracted position sensor.

Once the reservoir is filled with icing to the desired level, the ram disk assembly can be lowered by the ram disk position cylinder. During this process, the ram disk thrust cylinder remains fully retracted. The ram disk is lowered by exhausting compressed air from the non-rod end of the cylinder. No pressure is applied to the rod end. Thus, the cylinder rod retracts only on the force of gravity. As a result, the disk assembly descends only gradually and gently. The use of two redundant fixed orifice flow controls in the pressure line to the cylinder assures that motion is very slow and gentle. This is essential to assure that the motion is safe and predictable for the machine operator.

The ram disk is rotated by the operator as it descends to roughly correspond in position with the bore of the reservoir. In conjunction with this, the cone shaped peripheral seal retainer serves to help guide the disk assembly to approximate concentricity with the reservoir. The ram disk and its associated thrust cylinder are mounted to a mount bar which is attached to the disk position cylinder. As the disk assembly moves downward, the mount bar gently comes into contact with a support rest on one end. The other end of the bar is supported by the cylinder rod, which is at the end of its travel. Thus the downward motion of the disk assembly stops. At this juncture, the disk is closely positioned to the upper rim or lip of the reservoir, but is not in contact with the lip.

In preparation for the ram disk assembly to actually enter the reservoir, it must be made exactly concentric with the bore of the reservoir and it must be firmly mounted relative to the reservoir. This is simply and easily accomplished by slightly rotating the disk assembly until the clamp tabs on the mount bar are aligned with the mount bar locking clamps (two or more may be used), and the clamps are then secured such that the bar is locked and the ram disk is concentric with the reservoir. Critically, a sensor on each clamp confirms that the clamp is locked and, when summed, the clamp signals prove that the disk is concentric and safe to thrust into the reservoir. Also critically, once the clamps are locked, air pressure cannot be applied to the ram disk position sensor and, conversely, thrust pressure cannot be applied to the thrust cylinder.

With the ram disk concentric to the reservoir and locked in place, the circumferential space between the edge of the disk assembly and the reservoir rim is minimal and much less than required for a finger to come between the two surfaces. Thus a safe condition for applying thrust to the ram disk is assured. This method of establishing concentricity of the disk to the reservoir also assures that the peripheral seal and backer plate can enter the reservoir without the chance of being misaligned with potential resultant damage.

The ram disk thrust cylinder is equipped with a fixed orifice flow control which assures that its motion cannot be rapid or unpredictable. Thus, as pressure is applied to the piston end of this cylinder, the disk gradually enters the reservoir and bears against the icing within, applying a downward force to the icing mass and forcing it to the throat of the pump. In this regard, it is important to note that the total force applicable to the icing is determined and limited by the ratio of the cylinder bore to the reservoir bore, as detailed in object of invention 33.

With force applied to the icing in the reservoir, the pump may now be rotated and primed as may the outfeed structure until flow of icing occurs at the dispensing nozzle. As the icing level in the reservoir drops, the ram disk moves downward and continues to apply priming force to the pump infeed.

As previously noted, icing is typically full of air pockets. This high gas content of the icing requires the forced feed method herein disclosed to be used to supply icing to the system pump. Absent this method, the icing pump will periodically cavitate because of large air pockets in the icing and flow of icing will cease. Because of the relatively long outfeed functionally required by the design of the machine, after cavitation occurs the pump becomes what is know as “air bound” and further flow of icing is prevented because the pump cannot displace the air pocket into the discharge line due to the flow resistance presented by the discharge line.

The use of a sanitary gear pump is also crucial to the utility of the invention. The relatively high pump discharge pressures required to achieve adequate icing flow rates (typically above 100 psi at 1 GPM or more) cause erratic or pulsatile flow in typical sanitary rotary positive displacement pumps such as circumferential piston types and lobe types. This pulsing is actually a cessation or dramatic drop in flow as these pump rotors reach a crossover point. Specifically, when gas pockets in the icing are encountered at these rotor crossover points, the rotors rapidly advance through their rotation causing a highly erratic operation and irregular icing flow.

Uniquely, the sanitary gear pump utilized with this invention overcomes the described problem. This is because the gear pump design takes many more small “bites” of icing per rotation in its operation and provides much more uniform flow integration with its discharge geometry. The result of this design is that icing flow is smooth and continuous and stable in flow rate and free of gas pocket bind up.

The icing discharge structure from the pump to the icing dispense nozzle is of a particular nature. Most of the discharge distance to the nozzle is comprised of rigid tubing such as sanitary stainless steel. This allows the relatively high pressure on the discharge of the pump to be contained without distension of the flow conduit. The rigid portion of the outfeed terminates in a high pressure fast-acting shut-off valve.

Taken together, the rigid outfeed and high pressure valve allow the discharge pressure, once initially established, to be maintained for extended periods. This is important because the gas filled icing is compressible. Thus, if the discharge line from the pump to the nozzle were allowed to depressurize to atmosphere with each flow event, two problems would be encountered. First, the flow would continue long after the end of pump rotation and only gradually diminish. The adverse practical implications of this are clear. Second, when flow was called for, there would be a substantial delay of one to several seconds after the start of pump rotation before flow at the nozzle would start. Again, the unsuitability of such a machine is clear.

The use of the rigid outfeed in conjunction with the high pressure valve cures both described problems. With the use of the valve, which corresponds in action with that of the pump, flow at the nozzle is nearly instantaneous when called for, and stops immediately when so commanded.

It should also be noted that the outfeed from the valve to the nozzle is a flexible tube. This flexible line does not contribute to start of flow latency because the pressure drop from the high pressure valve to the nozzle is modest and thus results in substantially less gas compression, and gas entering this portion of the line is already compressed.

Further, another shut-off valve, capable of relatively lower differential pressure sealing, is fitted internally in the icing dispensing nozzle. This valve maintains the flexible tube portion of the outfeed at some elevated pressure between flow periods.

As icing in the reservoir is utilized, the ram disk moves downward until it reaches the end of the concentric bore portion of the vessel. Further downward movement is prevented by the full extension of the stroke of the thrust cylinder rod, which is detected by the ram disk thrust cylinder full extension position sensor. When this signal is presented to the controller, further icing metering is prevented since the reservoir is essentially empty. It should also be noted that the cone shaped ram disk backer plate displaces most of the icing in the cone bottom area of the reservoir.

Refilling the reservoir can be accomplished in two ways. Using the full extended sensor signal, a remote feed source of icing can supply additional material through a bottom refill fitting 120. In this case, the feed source overcomes the thrust pressure in the thrust cylinder using a relieving type regulator pressurizing the cylinder. Refill flow occurs until the ram disk thrust cylinder full retract position sensor is made. With this method, the icing applicator machine can remain in continuous operation.

The second means of refilling the reservoir is manual. With this method, a vacuum breaker valve must first be opened so that as the ram disk moves upward a vacuum is not created below the disk which would effectively prevent ram disk removal from the reservoir. The vacuum valve function can be mechanically or electrically automated, as desired. For example, a sanitary check valve could serve this function.

Once the vacuum valve is sensor verified as opened, pressure on the thrust cylinder is reversed. A fixed orifice flow control on the lift side of the cylinder limits the rate of movement.

When the thrust cylinder upper sensor detects that the disk assembly is out of the reservoir, the locking clamps can be released. The locking clamp sensors then allow actuation of the ram disk position cylinder such that the assembly is slowly lifted for manual reservoir reloading.

The mast and boom combination provided for with the invention allows the machine to be placed and used with convenience and particularly allows the icing dispensing nozzle to be readily maneuvered by the machine operator as necessary. The boom is provided with a pivot allowing a wide work area, enhanced by one or more sliding flexible tube supports and a slidable counter balance which supports the icing dispensing nozzle and further contributes to its maneuverability.

The icing dispensing nozzle as shown in FIGS. 9A and 9B is designed to be ergonomic and easy to use. It is provided with a round handle portion and a manually operated nozzle lever, the lever actuating a coaxial flow valve internal to the nozzle body. This valve is relatively small and compact and is particularly designed not to contribute substantially to the mass of the nozzle. This nozzle valve serves primarily as a low pressure flow shut-off, with the primary flow valve being located remote from the nozzle, thus contributing significantly to the ease of use of the nozzle.

A machine run switch is integrated at the top of the grip handle and is actuated by a pin constituting one end of the lever actuated shaft, which also operates to open the valve. Flow of icing beyond the valve is into a generally wedge shaped, horn-like structure which serves to alter the icing flow into a relatively wide ribbon. Many different shapes and designs of final flow structure are possible and useful, but regardless of shape, this portion of the nozzle serves not only as a flow orifice but also as a spreading, shaping, and smoothing tool which can be used by the operator to actually manipulate icing on the cake. This is important in that a separate spatula or cake icing knife is not required to achieve aesthetically pleasing results, saving substantial time and effort in the cake icing process. This is aided by provision to be able to alter the flow rate of the icing over a broad range, further contributing to speed of icing application and ease of use. The versatility of the machine is such that it is capable of use for icing cakes of essentially any conceivable size of shape. Use of the dispensing nozzle as a spreading tool also results in a dramatic reduction in total manual motion to ice a cake, often by as much as one half.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. Apparatus for applying icing to baked goods of any shape, such as cakes, the apparatus comprising:
a positive displacement sanitary design gear pump which meets 3A sanitary standards, the pump having symmetrical displacement rotors;
means for force feeding icing into the sanitary pump, the force feeding means including an icing reservoir;
an icing dispensing nozzle assembly including a positive shut-off valve; and
means for establishing an icing flow pathway which extends from the discharge of the pump to the icing dispensing nozzle assembly;
whereby icing can be reliably metered in a uniform way free of flow interruptions and variations caused by pump cavitation at its infeed or by flow stoppage at its discharge, both conditions typically resulting from pumping viscous icings full of gas products.

2. The apparatus for applying icing to baked goods as set forth in claim 1 wherein the apparatus further including a wheeled machine base which supports the positive displacement sanitary design gear pump, the means for force feeding icing into the sanitary gear pump, and the means for establishing an icing flow pathway from the discharge of the pump to an icing dispensing nozzle so that the apparatus can be easily moved by only one worker of average strength and stature, and wherein the icing reservoir is mounted for removal without the use of tools thus allowing easy periodic loading of the reservoir with icing by workers of average stature and strength.

3. The apparatus for applying icing to baked goods as set forth in claim 2, further including a vertical mast and a horizontal beam both of which support the icing flow pathway between the discharge of the pump and the point of icing deposit, thus allowing ease of machine positioning and use in many varied settings and layouts.

4. The apparatus for applying icing to baked goods as set forth in claim 3, wherein the vertical icing flow pathway supported by the vertical mast is constructed of rigid material, typically stainless steel tubing, for enhancing durability in the intended use of the machine, and for eliminating the distension evident in flexible tubes when subjected to substantial interval pressure, and wherein a relative short flexible product feed tube extends between the rigid flow pathway and the icing dispensing nozzle assembly.

5. The apparatus for applying icing to baked goods as set forth in claim 4, in which the rigid vertical icing flow pathway is segmented into separable shorter length sections for the express purpose of allowing ease of hand cleaning and inspection, and wherein the shorter length sections are fastened by sanitary connectors.

6. The apparatus for applying icing to baked goods as set forth in claim 1 in which the sanitary pump includes a pump housing having a pump body bore extending from one end to the other end of the housing; two spaced apart gear shaft bearing blocks mounted within the pump body bore, which blocks constitute hand removable structural end bodies of the gear pump, each of the bearing blocks including a pair of gear shaft support bearing holes which are through holes extending completely through the bearing blocks, each bearing block extending outward of the pump housing thus facilitating hand assembly and disassembly of the bearing block into and out of the pump housing; and wherein the symmetrical displacement rotors are drive and idler gear assemblies disposed within the pump body bore, the drive and idler gear assemblies including gear shafts which extend through the gear shaft support bearing holes and meshing drive and idler gears mounted between the ends of gear shafts, the drive and idler gears being received in a portion of the bore between the spaced apart bearing blocks.

7. The apparatus for applying icing to baked goods as set forth in claim 1 in which the pump in-feed port is oriented vertically to the reservoir outfeed port which is located directly above and centered on the pump, the apparatus further including an outfeed port fitting which is centered on the bottom of the icing reservoir and is only as long as is required to allow a clamp to be fitted to couple the reservoir port to the pump port.

8. The apparatus for applying icing to baked goods as set forth in claim 1 in which a ram disk assembly is used to force the icing to the pump in-feed, the ram disk assembly being locatable within the icing reservoir.

9. The apparatus for applying icing to baked goods as set forth in claim 8 wherein the reservoir is cylindrical and the ram disk is circular.

10. The apparatus for applying icing to baked goods as set forth in claim 9 further characterized by the provision of a flexible single convolution beaded peripheral circumferential seal element, in which the ram disk serves as a carrier and backer plate for the flexible single convolution beaded peripheral circumferential seal element, the seal being pressure activated by mechanical contact with the top of icing in the icing product reservoir, the single convoluted shape of the circumference seal element allowing the unloaded seal diameter to be smaller than the icing reservoir internal diameter, thus permitting easy insertion of the seal into and withdrawal from the reservoir, while still allowing sealing to occur against the reservoir wall as a result of seal diameter increase as the single convolution of the seal is forced against the icing reservoir wall by the ram disk.

11. The apparatus for applying icing to baked goods as set forth in claim 8 in which a motion controlled pneumatic cylinder assembly is provided, the ram disk assembly being secured to the cylinder assembly so that it can be raised away from or lowered into the icing reservoir by use of a motion controlled pneumatic cylinder.

12. The apparatus for applying icing to baked goods as set forth in claim 11 further characterized by the provision of means for raising and lowering the pneumatic cylinder assembly, the raising and lowering means supporting the pneumatic cylinder assembly for swinging motion so that the ram disk, when in its raised position away from the reservoir, can be freely moved to one side by hand, thus allowing free and unimpeded access to the reservoir for loading with icing or for removal or for cleaning in situ.

13. The apparatus for applying icing to baked goods as set forth in claim 12 in which the means for raising and lowering the pneumatic cylinder includes a mount bar, which mount bar may be securely fixed to the reservoir to allow thrust to be applied to the disk and hence to the icing, the mount bar being secured by use of at least two handle-operated locking clamps, the clamps fixing the mount bar to a reservoir mounting frame, and wherein each ram disk mount bar locking clamp is fitted with a sensor which detects the position of each clamp as locked or unlocked, and control means to insure that force cannot be applied by the ram disk against icing in the reservoir unless all clamps are in a locked position as determined by the mount bar locking clamp sensors, thus assuring safe machine operation.

14. The apparatus for applying icing to baked goods as set forth in claim 9 wherein the bottom portion of the reservoir is conical, and wherein the ram disk assembly includes a conical seal retainer for retaining a peripheral seal, the seal retainer having a cone angle which matches the conical bottom of the reservoir, thus allowing the conical seal retainer to extend into the conical bottom portion of the icing reservoir when the ram disk is fully extended down into the reservoir, thus allowing the ram disk to displace nearly all of the icing contained within the reservoir.

15. The apparatus for applying icing to baked goods as set forth in claim 14 wherein a ram disk thrust cylinder is used to move the ram disk up and down, and wherein a vacuum breaker valve is fitted to the bottom cone portion of the icing reservoir such that, prior to activation of the ram disk thrust cylinder to raise the ram disk assembly to the top of the reservoir, the valve is opened, allowing air to flow into the reservoir below the ram disk, thus assuring that atmospheric pressure is maintained on both sides of the disk as it is raised.

16. The apparatus for applying icing to baked goods as set forth in claim 1 wherein the bottom portion of the reservoir is conical, and wherein the reservoir is provided with a fitting near the bottom of the conical portion of the reservoir whereby the icing reservoir may be automatically refilled without removal of the ram disk assembly from the reservoir by forcing icing into the reservoir from another source using the fitting.

17. The apparatus for applying icing to baked goods as set forth in claim 4 wherein a fast acting positive shut-off valve is provided, the valve being located at the end of the rigid vertical icing flow discharge pathway and before the flexible product feed tube, the valve providing high pressure shut-off of icing flow, thus assuring immediate icing flow stoppage when the icing pump is stopped, and doing so without adding the mass of the valve to the moveable portion of the icing dispense nozzle, thus enhancing the ergonomics of the machine, and to assure immediate initiation of icing flow when the icing pump is rotated, the valve maintaining the gas filled icing in a compressed and pressurized condition between icing flow events, thus eliminating the flow latency period that is evident without such a valve.

18. The apparatus for applying icing to baked goods as set forth in claim 17 in which the icing dispense nozzle has only a small low pressure shut-off valve integrated into its structure, thus allowing the nozzle to be relatively light and easy to manipulate, the valve serving only to prevent drip or ooze of icing at the nozzle, and an icing flow on-off switch integrated with the low pressure shut-off valve, thus integrating high pressure pumping and the fast acting high pressure positive shut-off valve with the low pressure nozzle valve.

19. A reservoir assembly for use with an apparatus for applying icing to baked goods, such as cakes; said reservoir assembly comprising:
a cylindrical icing reservoir having a conical bottom portion provided with an outfeed port;
a ram disk assembly which is movable from a position above the reservoir to a position adjacent the conical bottom portion of the reservoir, the ram disk assembly including a ram dick backer plate, a conical peripheral seal retainer, and a flexible one convolution beaded peripheral circumferential seal element on disc;
a motion controlled pneumatic cylinder assembly for raising and lowering the ram disk assembly, the pneumatic cylinder being supported for swinging motion so ram disk in raised position can be freely moved to one side by hand; and
means for raising and lowering the pneumatic cylinder assembly, whereby the cylinder assembly can be moved to one side when in the raised position.

20. The apparatus for applying icing to baked goods as set forth in claim 19 wherein a mount bar is securely fixed to the reservoir, the mount bar supporting the pneumatic cylinder, and wherein the means for raising and lowering the pneumatic cylinder assembly is a cylinder assembly secured adjacent the reservoir, which cylinder raises and lowers the mount bar, and wherein the mount bar is secured in a lowered position by use of at least two handle-operated locking clamps, and wherein a sensor is provided which detects each clamp as locked or unlocked, and control means to insure that force cannot be applied by the ram disk against icing in the reservoir unless all clamps are in a locked position as determined by the mount bar locking clamp sensors, thus assuring safe machine operation.

21. Method for applying icing to baked goods of any shape, such as cakes, the apparatus comprising:
providing a positive displacement sanitary design gear pump which meets 3A sanitary standards, the pump having symmetrical displacement rotors, and an icing dispensing nozzle assembly including a positive shut-off valve;
force feeding icing into the sanitary pump; and
causing the pump to deliver icing to the dispensing nozzle in a uniform way free of flow interruptions and variations caused by pump cavitation at its infeed or by flow stoppage at its discharge, both conditions typically resulting from pumping viscous icings full of gas products.
